(19) United States
(12) Patent Application Publication
(10) Pub. No.: US 2010/0186487 A1
(43) Pub. Date: Jul. 29, 2010

(54) CANTILEVER-TYPE SENSOR, AS WELL AS A SUBSTANCE SENSING SYSTEM AND A SUBSTANCE SENSING METHOD THAT USE THE SENSOR

(76) Inventor: Yukio Sakashita, Kanagawa (JP)

Correspondence Address: BIRCH STEWART KOLASCH & BIRCH, PO BOX 747, FALLS CHURCH, VA, 22040-0747, US

(21) Appl. No.: 12/676,064

(22) PCT Filed: Sep. 10, 2008
(86) PCT No.: PCT/JP2008/066796

§ 371 Date: Mar. 2, 2010

(30) Foreign Application Priority Data
Sep. 13, 2007 (JP) 2007-238074

(51) Int. Cl. G01N 5/02

(52) U.S. Cl. 73/73

(57) ABSTRACT

The cantilever-type sensor detects a substance to be measured as it is contained in a liquid. The sensor includes a cantilever that is fixed at least at an end to a support section and which has a channel formed inside, a piezoelectric device that is composed of a piezoelectric element and electrode sections formed on opposite sides of the piezoelectric element and which is positioned on at least one side of the cantilever, a drive section that applies a voltage to the electrode sections of the piezoelectric device so as to vibrate the cantilever, a detecting section that detects vibration of the cantilever from expansion or contraction of the piezoelectric device and a liquid supply unit for flowing the liquid through the channel in the cantilever. The cantilever-type sensor features high precision in measurement and is compact and less costly.

### TECHNICAL FIELD

The present invention relates to a cantilever-type sensor, as well as a substance sensing system and a substance sensing method that use the sensor.

### BACKGROUND ART

An increasing need has recently arisen, mostly in life sciences, to sense tiny substances such as proteins, cells, viruses and bacteria and a variety of apparatuses and methods for detecting such tiny substances have been developed.

Already commercialized, highly sensitive detection methods include optical techniques such as an SPR (surface plasmon resonance) measurement that utilizes the resonance of surface plasmons. Detecting apparatuses that use a cantilever-type sensor have also been proposed to detect tiny substances from the amount of deflection in the cantilever or the number of its vibrations (see JP 2004-506872 A and JP 2005-156526 A)

JP 2004-506872 A describes a sensor system having a measurement cantilever having a coating sensitive to a target substance applied to one of its surfaces and a reference cantilever having a coating insensitive to the target substance applied to one of its surfaces.

In this sensor system, the two cantilevers are exposed in a reference step to a reference liquid and in a detection step to the reference liquid having the target substance; the sensor system detects the difference in the deflection of the measurement cantilever and the reference cantilever during the reference step and the detection step. JP 2004-506872 A also describes a method of using an optical sensor to detect the deflection.

JP 2005-156526 A describes a cantilever sensor-type analyzer system having a cantilever with a drive membrane and an electric pad being superposed on the upper surface and a molecular recognition layer, formed of a substance reactive to a substance to be measured, being superposed on the lower surface.

In this system, the reactive substance is adhered to the molecular recognition layer in the cantilever, which is then vibrated by the drive membrane and the resulting frequency from it is sensed with the electric pad to detect the resonance frequency. The sensed resonance frequency is compared with the value of resonance frequency that has been measured without adhering the reactive substance to the molecular recognition layer, whereby the mass of the reactive substance adhering to the molecular recognition layer is detected.

Nature, vol. 446, pp. 1066-1069 (2007) describes a cantilever-type sensor that has a channel provided in a cantilever and with which a liquid to be measured or a liquid that contains a target to be measured is flowed through the channel to measure the mass of the target being measured.

### DISCLOSURE OF THE INVENTION

A problem with the method of adsorbing a substance on one surface of the cantilever as in the systems described in JP 2004-506872 A and JP 2005-156526 A is that since the cantilever is placed within the fluid, its mechanical quality factor Q deteriorates to lower the sensitivity of measurement.

As a further problem, the target to be measured is selectively adsorbed by the antigen-antibody reaction but the occurrence of a non-specific adsorption precludes a higher precision in measurement.

On the other hand, forming a channel inside a cantilever as described in Nature, vol. 446, pp. 1066-1069 (2007) enables the cantilever to vibrate in the air and the mechanical quality factor Q that can be achieved is higher than when it is vibrated in a solution. As a further advantage, measurement can be performed without adsorbing the substance of interest on the cantilever and, hence, without the occurrence of non-specific adsorption.

However, the cantilever described in Nature, vol. 446, pp. 1066-1069 (2007) involves the problem of bulkiness since the apparatus uses a drive mechanism that vibrates the cantilever by an electrostatic system and a detector section that detects a deflection with an optical sensor.

The present invention has been accomplished with a view to solving the above-mentioned problems of the prior art and a first object of the invention is to provide a cantilever-type sensor that features high precision in measurement and which is compact and less costly.

Another object of the present invention is to provide a substance sensing system that uses the sensor.

Still another object of the present invention is to provide a substance sensing method that uses the sensor.

The first object of the present invention can be attained by its first aspect which provides a cantilever-type sensor for detecting a substance to be measured as it is contained in a liquid, comprising: a cantilever that is fixed at least at an end to a support section and which has a channel formed inside; a piezoelectric device that is composed of a piezoelectric element and electrode sections formed on opposite sides of the piezoelectric element and which is positioned on at least one side of the cantilever; a drive section that applies a voltage to the electrode sections of the piezoelectric device so as to vibrate the cantilever; a detecting section that detects vibration of the cantilever from expansion or contraction of the piezoelectric device; and liquid supply means for flowing the liquid through the channel in the cantilever.

In terms of enhancing the piezoelectric characteristics, the piezoelectric element is made of a composition of a Pb-containing perovskite crystal. In terms of environmental protection, the piezoelectric element is made of a composition of a Pb-free perovskite crystal. The Pb-free composition referred to hereinabove is a composition with a Pb content of not more than 0.1 wt %.

It is preferable for only one end of the cantilever to be fixed to the support section. It is also preferable for both ends of the cantilever to be fixed to the support section.

The second object of the present invention can be attained by its second aspect which provides a substance sensing system comprising: the cantilever-type sensor as described above; a frequency computing section which computes a first resonance frequency of the cantilever from a value detected by the detecting section; and a sensing section which compares the first resonance frequency computed by the frequency computing section with a second resonance frequency of the cantilever for a case where a liquid not containing the substance to be measured is flowed through the channel and which relies on a result of comparison to sense the substance to be measured as it is inside the channel.

It is preferable for the sensing section to rely on the result of comparison to sense a mass of the substance being measured.

It is also preferable for the sensing section to rely on the result of comparison to sense presence or absence of the substance being measured.

The third object of the present invention can be attained by its third aspect which provides a substance sensing method for sensing a substance to be measured within a liquid, comprising: flowing the liquid through a channel formed inside a cantilever having a piezoelectric device positioned on at least one side thereof; applying a voltage to the piezoelectric device so that the piezoelectric device is expanded or contracted to vibrate the cantilever as the liquid is flowing therethrough; detecting vibration of the cantilever with the piezoelectric device; detecting from the detected vibration a first resonance frequency of the cantilever as the liquid is flowing therethrough; comparing the detected first resonance frequency with a second resonance frequency of the cantilever for a case where a liquid not containing the substance to be measured is flowed through the channel; and sensing the substance to be measured from a result of comparison.

In the substance sensing method, the mass of the target being measured is preferably sensed from the result of comparison.

According to the present invention, sensing can be effected by flowing a liquid through the channel formed inside the cantilever, so the cantilever can be vibrated in the air; in addition, sensing can be effected as the target to be measured is flowed through the channel without adsorbing it to the cantilever and, hence, sensing can be achieved without the occurrence of non-specific adsorption. This contributes to a higher precision in measurement.

As a further advantage, the piezoelectric device can perform two functions, vibrating the cantilever and detecting its vibration; this contributes to simplifying the configuration of the apparatus and reducing its size.

Since the configuration of the apparatus can be simplified and its size reduced, the entire system can be easily adapted to have an array configuration.

### BRIEF DESCRIPTION OF THE DRAWINGS

FIG. 1 is a schematic view showing a diagrammatic configuration of a substance sensing system according to the second aspect of the present invention which uses a cantilever-type sensor according to the first aspect of the present invention.

FIG. 2 is a perspective view showing diagrammatically how a cantilever and a support section together form the main body of the cantilever-type sensor depicted in FIG. 1.

FIG. 3A is a section through the topside of the main body of the cantilever-type sensor used in the substance sensing system depicted in FIG. 1.

FIG. 3B is a section through a lateral side of the main body of the cantilever-type sensor used in the substance sensing system depicted in FIG. 1.

FIG. 4 is a flow sheet for illustrating an example of the substance sensing method according to the third aspect of the present invention.

FIG. 5 is a flow sheet for illustrating the same example of the substance sensing method according to the third aspect of the present invention.

FIG. 6 is a flow sheet for illustrating another example of the substance sensing method according to the third aspect of the present invention.

FIG. 7 is a top view showing a diagrammatic configuration for another example of the cantilever-type sensor according to the first aspect of the present invention.

FIGS. 8A to 8K show in sequence the steps in the process of preparing the main body of the cantilever-type sensor according to the first aspect of the present invention.

### BEST MODES FOR CARRYING OUT THE INVENTION

The cantilever-type sensor according to the first aspect of the present invention, the substance sensing system that uses it according to the second aspect of the invention, and the substance sensing method that uses it according to the third aspect of the present invention are described below in detail with reference to the embodiments depicted in the accompanying drawings.

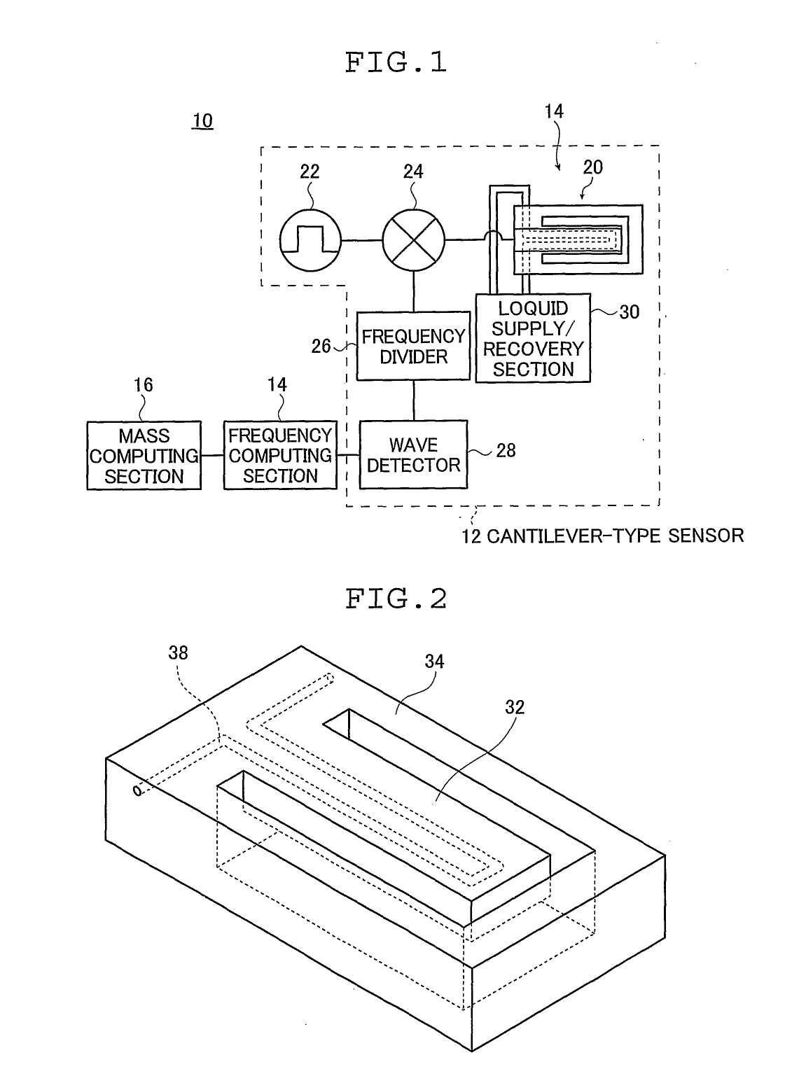

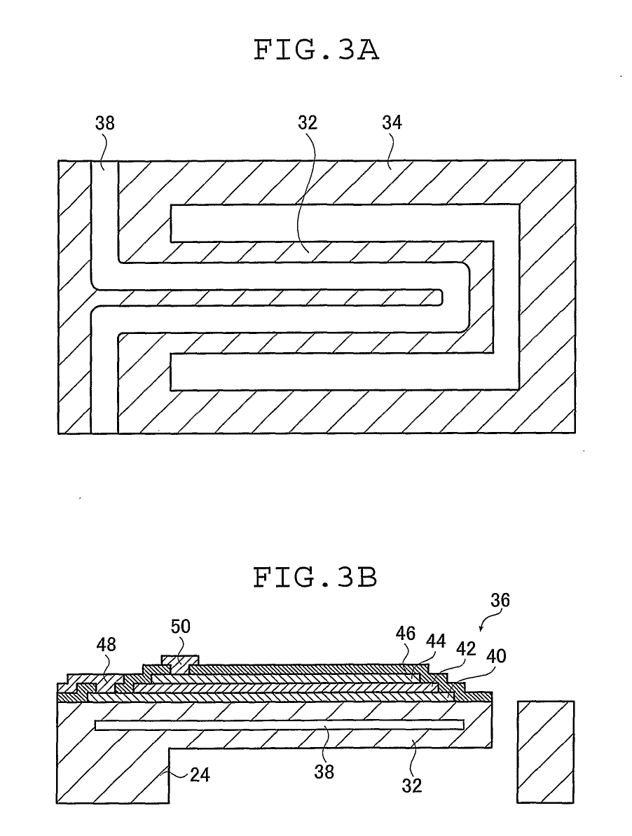

FIG. 1 is a schematic view showing a diagrammatic configuration of the substance sensing system according to the second aspect of the present invention which uses the cantilever-type sensor according to the first aspect of the present invention; FIG. 2 is a perspective view showing diagrammatically how a cantilever and a support section together form the main body of the cantilever-type sensor depicted in FIG. 1; FIG. 3A is a section through the top side of the main body of the cantilever-type sensor depicted in FIG. 1; and FIG. 3B is a section through a lateral side of the main body of the cantilever-type sensor depicted in FIG. 1.

As shown in FIG. 1, the substance sensing system generally indicated by 10 comprises a cantilever-type sensor 12, a frequency computing section 14, and a mass computing section 16; the cantilever-type sensor 12 is so adapted that a liquid containing a target to be measured flows inside a cantilever, the resonance frequency of which varies with the target to be measured as it flows inside; the frequency computing section computes the resonance frequency of the cantilever-type sensor 12; and relying on the resonance frequency computed in the frequency computing section 14, the mass computing section 16 computes the mass of the target being measured.

The target to be measured as referred to above is a tiny substance which is exemplified by proteins, cells, viruses, bacteria, nano-particles, beads, etc.

The liquid which is to contain the target to be measured is not limited in any particular way and may be exemplified by water, alcohol, etc.

Let us first describe the cantilever-type sensor 12. The cantilever-type sensor 12 comprises a main body 20, a signal source 22, a mixer 24, a branching filter 26, a wave detector 28, and a liquid supply/recovery section 30.

As shown in FIGS. 2, 3A and 3B, the main body 20 has a cantilever 32, a support section 34 which supports an end of the cantilever 32, and a piezoelectric device 36 positioned on the topside of the cantilever 32.

The cantilever 32 is a beam supported at one end by the support section 34. The support section 34 is a base that supports one end of the cantilever 32 and it is formed integral with the cantilever 32.

The cantilever 32 and the support section 34 have a channel 38 formed in their interiors.

As shown in FIG. 2, the channel 38 starts from the support section 34 and passes through the basal end of the cantilever 32 to extend to its distal end, where it changes its direction and returns back toward the basal end of the cantilever 32 and passes through the support section 34.

In short, that part of the channel 38 which is formed inside the cantilever 32 is formed in a U-shape, i.e., it returns in opposite direction at the distal end. That part of the channel 38 which is formed inside the support section 34 consists of two sub-channels that connect to the two sub-channels that run in the basal end portion of the cantilever 32. Each of the two sub-channels 38 running through the support section 34 connects to the liquid supply/recovery section 30 which is to be described later.

The piezoelectric device 36 is positioned on the topside of the cantilever 32 and comprises a lower electrode 40, a piezoelectric element 42, an upper electrode 44, a protective layer 46, as well as pickup electrodes 48 and 50.

The lower electrode 40 is an electrode in plate form that is positioned on the topside of the cantilever 32. The lower electrode 40 is connected to the mixer 24 to be described later via the pickup electrode 48.

The lower electrode 40 as referred to above can be prepared from various materials including, for example, metals such as Au, Pt and Ir, metal oxides such as IrO₂, RuO₂, LaNiO₃ and SrRuO₃, and combinations thereof.

The piezoelectric element 42, formed on the lower electrode 40, is a member having a certain thickness in the direction from the upper electrode 44 to the lower electrode 40 (from top to bottom in FIG. 3B). The piezoelectric element 42 is formed of a material that expands or contracts in response to a change in the voltage being applied or which outputs a specified voltage when it is expanded or contracted; in the embodiment under consideration, the piezoelectric element 42 is formed of PbₓB_{y}O_{z} as the primary component, where x, y and z are each any real number, B is a site B element which is at least one member of the group consisting of Ti, Zr, V, Nb, Ta, Cr, Mo, W, Mn, Sc, Co, Cu, In, Sn, Ga, Zn, Cd, Fe and Ni. A standard case for the piezoelectric element is where x=y=1 and z=3 but x and y may be changed to take on various other values within the range over which the perovskite structure can be realized. If the piezoelectric element is formed of PbₓB_{y}O_{z} as the primary component, its piezoelectric characteristics such as piezoelectric coefficient can be enhanced by designing it to have the perovskite structure. This offers the advantage of causing significant expansion and contraction to occur in response to the application of only a small voltage.

The piezoelectric element 42 as referred to above preferably contains lead zirconate titanate (PZT) as the primary component, in which Zr and Ti are site B elements. Using PZT as the primary component contributes to enhanced piezoelectric characteristics and a comparatively low price.

The material of the piezoelectric element is not limited to lead zirconate titanate (PZT) and it may use other lead-containing compounds such as lead titanate, lead zirconate, lead lanthanum titanate, lead lanthanum zirconate titanate, and lead magnesium niobate zirconium titanate.

In the embodiment under consideration, PbₓB_{y}O_{z} is used as the primary component of the piezoelectric element 42 but if desired, compounds that do not have lead at so-called site A may also be used and examples include bismuth potassium titanate, sodium niobate, potassium niobate, lithium niobate, bismuth ferrite, and solid solutions thereof.

In the case where the piezoelectric element is formed of the composition described above, it is preferred again to adapt it to have the perovskite structure. Forming the piezoelectric element of the composition that is adapted to have the perovskite structure contributes to enhanced piezoelectric characteristics.

Using a piezoelectric element that is formed of a Pb-containing composition with the perovskite structure contributes to still enhanced piezoelectric characteristics whereas using a piezoelectric element that is formed of a Pb-free composition with the perovskite structure as mentioned above contributes to environmental protection. The Pb-free composition as referred to above is such a composition that the Pb content is not more than 0.1 wt % and this may be exemplified by the various materials listed above.

As noted above, it is preferred to use piezoelectric elements having the perovskite structure but the present invention is not limited to this particular case and it is also possible to use piezoelectric elements that are prepared from zinc oxide (ZnO), aluminum nitride (AlN), and ditantalum pentoxide (Ta₂O₅).

The piezoelectric element 42 as referred to above can be prepared by various methods including bulk sintering, screen printing, and spin coating but it is preferred to prepare the piezoelectric element by vapor-phase growth techniques. Specifically, it is preferred to prepare the piezoelectric element by a variety of vapor-phase growth techniques including one that employs plasma, as well as ones that employ light, heat, etc. as exemplified by sputtering, ion-beam sputtering, ion plating, PLD (pulsed laser deposition), and CVD (chemical vapor deposition).

Vapor-phase growth techniques enable the piezoelectric element to be prepared without performing annealing or any other extra treatment, so lead loss and other problems can be prevented to assure the formation of uniform piezoelectric elements.

The upper electrode 44 is also an electrode in plate form, which is positioned on the side of the piezoelectric element 42 which is away from the side where the lower electrode 40 is positioned. In other words, the upper electrode 44 and the lower electrode 40 are positioned in such a way that they hold the piezoelectric element 42 in between. The upper electrode 44 is connected to the mixer 24, which is to be described later, via the pickup electrode 50.

The upper electrode 44 can be prepared from various materials including, for example, metals such as Au, Pt and Ir, metal oxides such as IrO₂, RuO₂, LaNiO₃ and SrRuO₃, electrode materials such as Al, Ta, Cr and Cu that are commonly employed in semiconductor processes, and combinations thereof.

If desired, in order to have better adhesion to the piezoelectric element, the upper electrode 44 may have a multi-layer structure comprising an adhesive layer and an electrode layer in superposition.

Finally, the protective layer 46 is formed of an insulating material such as SiO₂ and covers all exposed areas of the lower electrode 40, the piezoelectric element 42 and the upper electrode 44, except where the pickup electrodes 48 and 50 are provided. By providing the protective layer 46, no areas of the lower electrode 40, the piezoelectric element 42 and the upper electrode 44 are left exposed, thus preventing the occurrence of accidents such as electric discharge and electrical leak.

Described above is the basic configuration of the main body 20 of the cantilever-type sensor 12.

We next describe the signal source 22; this is a power source for applying a voltage and it is connected to the lower electrode 40 and the upper electrode 44 in the piezoelectric device 36 via the mixer 24.

The mixer 24 is connected to the piezoelectric device 36, the signal source 22 and the branching filter 26. The mixer 24 supplies the piezoelectric device 36 with the voltage outputted from the signal source 22 and it also supplies the branching filter 26 with the voltage outputted from the piezoelectric device 36.

The branching filter 26 receives from the mixer 24 the voltage that has been generated in response to the deformation the piezoelectric element 42 in the piezoelectric device 36 experienced when the cantilever 32 vibrated; the branching filter 26 divides the received voltage into frequency components.

The outputs of the respective frequency components from the branching filter 26 are fed into the wave detector 28, which computes the intensity and other parameters of each frequency component.

The liquid supply/recovery section 30 connects to an end of each of the two sub-channels of the channel 38 running through the support section 34 such that it supplies the liquid into the channel 38 and recovers it after it has flowed through the channel 38.

The liquid supply/recovery section 30 as referred to above supplies two kinds of liquid, one containing the target to be measured and the other not containing it. The second type of liquid, which does not contain the target to be measured and which will be described later, is used to compute the reference for sensing the mass of the target being measured.

Described above is the basic configuration of the cantilever-type sensor 12.

The frequency computing section 14 computes the resonance frequency of the cantilever 32 on the basis of the value as detected by the wave detector 28.

The mass computing section 16 compares the resonance frequency of the cantilever 32 with the resonance frequency preliminarily detected from the cantilever 32 when the liquid not containing the target to be measured was flowed through the channel 38 and it then computes the mass of the target being measured on the basis of the difference between the two resonance frequencies.

We next describe the substance sensing method according to the third aspect of the present invention which uses the substance sensing system 10.

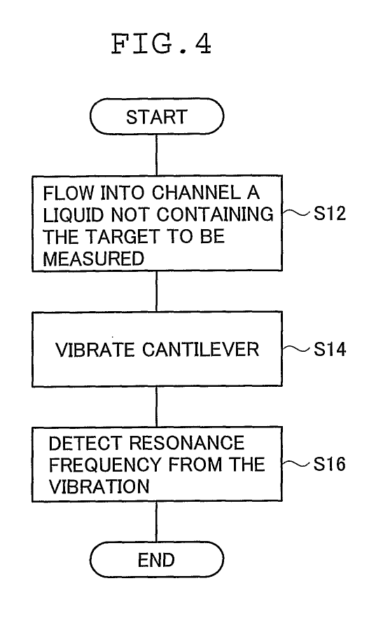

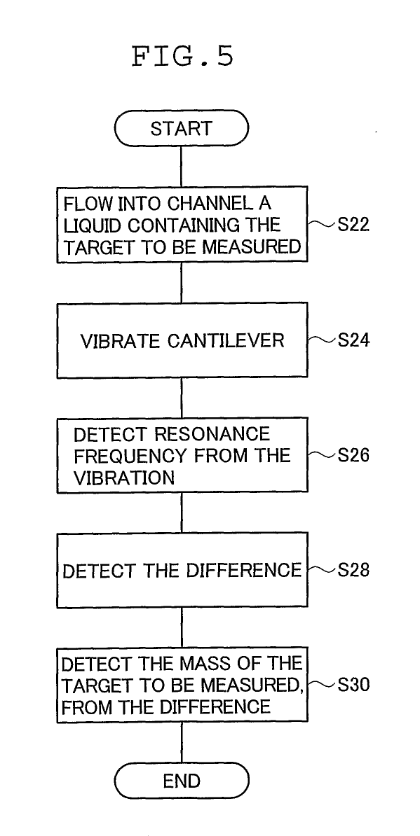

FIGS. 4 and 5 are each a flow sheet showing an embodiment of the substance sensing method of the present invention.

Before sensing the substance as the target to be measured, the substance sensing system 10 detects the resonance frequency of the cantilever as occurs when a liquid that does not contain the substance as the target to be measured is flowed through the channel.

First, the liquid that does not contain the target to be measured is flowed into the channel 38 from the liquid supply/recovery section 30 to establish a state in which the liquid that does not contain the target to be measured is flowing through the channel 38 in the cantilever 32 (step S12).

Then, the cantilever 32 through which the liquid is flowing is vibrated by the piezoelectric device 36 (step S14). Specifically, a pulsed wave of a specified potential is generated in the signal source 22 and applied to the upper electrode 44 in the piezoelectric device 36 via the mixer 24. Note that a fixed voltage is applied to the lower electrode 40. With voltage being thusly applied to the lower electrode 40 and the upper electrode 44, a potential difference develops in the piezoelectric element 42, causing it to expand or contract. As the piezoelectric element 42 expands or contracts, a force is exerted on the cantilever 32, causing it to be displaced by a certain amount. Thereafter, the cantilever 32 undergoes damped vibration until it returns to the initial position (i.e., the position before the displacement).

The resonance frequency of the cantilever 32 is then computed from its vibration (step S16). The specific procedure of the computation is as follows.

The force exerted on the piezoelectric element 42 causes the cantilever 32 to vibrate. When the cantilever 32 vibrates, the piezoelectric element 42 positioned on the topside of the cantilever 32 also expands or contracts. The piezoelectric element 42, upon expansion or contraction (i.e., when it is deformed), generates a voltage.

The voltage generated in the piezoelectric element 42 is detected by the lower electrode 40 and the upper electrode 44 and sent to the branching filter 26 via the mixer 24. The branching filter 26 divides the varied voltage from the mixer 24 into frequency components and sends them to the wave detector 28. The wave detector 28 detects the respective frequency components and sends the result of detection to the frequency computing section 14.

Relying on the frequency components of the vibration of the cantilever 32 as detected in the wave detector 28, the frequency computing section 14 computes the resonance frequency of the cantilever 32.

This is how the resonance frequency of the cantilever 32 is computed as the liquid that does not contain the target to be measured is flowing through the channel 38.

In the next step, the mass of the target being measured is computed.

First, the liquid that contains the target to be measured is flowed into the channel 38 from the liquid supply/recovery section 30 to establish a state in which the liquid that contains the target to be measured is flowing through the channel 38 in the cantilever 32 (step S22).

Then, the cantilever 32 through which the liquid is flowing is vibrated by the piezoelectric device 36 (step S24). Specifically, as in the aforementioned step S14, a specified voltage is applied to the upper electrode 44 in the piezoelectric device 36, causing the piezoelectric element 42 to expand or contract, whereupon the cantilever 32 is vibrated.

Then, the resonance frequency of the cantilever 32 is computed from its vibration (step S26). Specifically, as in the aforementioned step S16, the vibration of the cantilever 32 is detected by the piezoelectric device 36 and passed through the mixer 24, the branching filter 26 and the wave detector 28 to detect the respective frequency components of the cantilever's vibration. Thereafter, the frequency computing section 14 computes the resonance frequency of the cantilever 32 from the frequency components of the vibration of the cantilever 32 as detected in the wave detector 28.

This is how the resonance frequency of the cantilever 32 is computed as the liquid that contains the target to be measured is flowing through the channel 38.

Subsequently, the difference between the resonance frequency of the cantilever 32 as detected in step S26 while the liquid containing the target to be measured was flowing through the channel 38 and the resonance frequency of the cantilever 32 as detected in step S16 while the liquid not containing the target to be measured was flowing through the channel 38 is computed (step S28).

Specifically, in the mass computing section 16, the resonance frequency as detected in step S26 is compared with the resonance frequency as detected in step S16 and the difference between the two resonance frequencies is computed.

Then, the mass of the target being measured is detected from the computed difference in resonance frequency (step S30).

Specifically, relying upon the differential resonance frequency as computed in step S28, the mass computing section 16 computes the mass of the target being measured which is contained in the liquid flowing through the channel 38 in the cantilever 32.

This is how the mass of the target being measured is computed.

As described above, a channel is provided in a cantilever and a liquid that contains a target to be measured is flowed through the channel to measure the mass of that target to be measured; this enables the cantilever to be vibrated in the air. As a result, the mechanical quality factor Q can be increased compared to the case where the cantilever is positioned within the liquid and the mass of the target to be measured is sensed as it is vibrated while it remains attached to a surface of the cantilever.

In addition, the target to be measured need not be attached to the cantilever and this contributes to preventing the occurrence of non-specific adsorption; what is more, even those tiny substances that have been impossible to attach to the cantilever can be sensed, enabling a greater variety of tiny substances to be sensed.

As a further advantage, the interior of the channel can be cleaned by a simple procedure to remove the residual tiny substance, so the cantilever can be utilized more than once by a simple procedure of cleaning and, what is more, the likelihood that the target to be measured that was sensed in the previous cycle will remain unremoved is sufficiently lowered to increase the precision in measurement.

Further in addition, by utilizing the piezoelectric device not only to vibrate the cantilever but also to detect its vibration, namely, by causing the piezoelectric device to be responsible for both vibration of the cantilever and detection of its vibration, the apparatus can be made compact and less costly and its configuration can be simplified. Since the apparatus is produced at low cost, it can be adapted to be disposable.

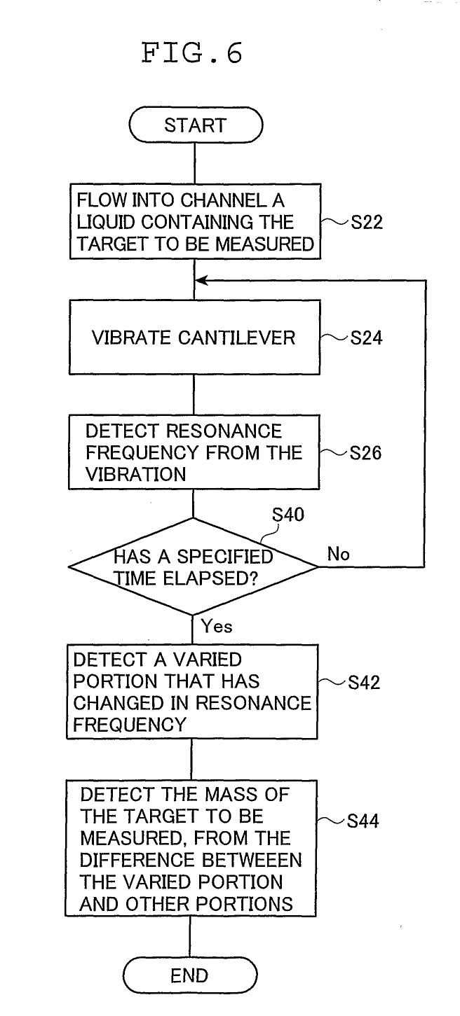

In the foregoing embodiment, the resonance frequency of the liquid that does not contain the target to be measured is determined in a preliminary step but this is not the sole case of the present invention. On the following pages, another example of the method of measurement is described with reference to FIG. 6.

FIG. 6 is a flow sheet for illustrating another example of the substance sensing method according to the third aspect of the present invention. The fluid used in this embodiment which contains the target to be measured is a liquid with a small content of the target to be measured and there are two cases for this, one in which the target to be measured is flowing through the channel 38 in the cantilever 32, and the other where it is not flowing.

First, the liquid that contains the target to be measured is flowed into the channel 38 from the liquid supply/recovery section 30 to establish a state in which the liquid that contains the target to be measured is flowing through the channel 38 in the cantilever 32 (step S22).

Then, the cantilever 32 through which the liquid is flowing is vibrated by the piezoelectric device 36 (step S24). Specifically, as in the aforementioned step S14, a specified voltage is applied to the upper electrode 44 in the piezoelectric device 36, causing the piezoelectric element 42 to expand or contract, whereupon the cantilever 32 is vibrated.

Then, the resonance frequency of the cantilever 32 is computed from its vibration (step S26). Specifically, as in the aforementioned step S16, the vibration of the cantilever 32 is detected by the piezoelectric device 36 and passed through the mixer 24, the branching filter 26 and the wave detector 28 to detect the respective frequency components of the cantilever's vibration. Thereafter, the frequency computing section 14 computes the resonance frequency of the cantilever 32 from the frequency components of the vibration of the cantilever 32 as detected in the wave detector 28.

This is how the resonance frequency of the cantilever 32 is computed as the liquid that contains the target to be measured is flowing through the channel 38.

Subsequently, a check is made to see if a specified time (i.e., a preset time of any length) has elapsed since the start of measurement (step S40).

If the specified time has not elapsed, namely, before the passage of the specified time, the process returns to step S24 and the cantilever 32 is vibrated again and the resonance frequency of the cantilever 32 is computed as the liquid containing the target to be measured is flowing through the channel 38. In other words, the detection of resonance frequency is repeated until the specified time elapses.

On the other hand, if the specified time is found to have elapsed in step S40, the process goes to step S42.

If the specified time has elapsed since the start of measurement, the resonance frequency of the cantilever 32 in which the liquid containing the target to be measured is flowing through the channel 38 (as detected more than once by repeating steps S24 and S26 until the specified time elapses) is relied upon to detect a portion that has a different resonance frequency than other portions (which is hereinafter sometimes referred to as “a varied portion”) (step S42).

Specifically, the resonance frequency as detected more than once varies depending upon whether the target to be measured flowed through the channel 38; hence, this resonance frequency as detected more than once is divided into two portions, one that has been detected while the target to be measured is flowing through the channel and the other that has been detected while the target to be measured is not flowing through the channel. Then, the resonance frequency that has been detected while the target to be measured is flowing through the channel is detected as a varied portion of resonance frequency.

Subsequently, the mass of the target being measured is sensed from the difference between the detected, varied portion of resonance frequency and the other portion of resonance frequency (step S44).

Specifically, the difference between the resonance frequency detected while the target to be measured is flowing through the channel and the resonance frequency of the cantilever 32 in which the liquid not containing the target to be measured is flowing through the channel 38 is computed and the mass of the target being measured that is contained in the liquid flowing through the channel 38 in the cantilever 32 is computed from the differential resonance frequency.

This is another way that may be employed to compute the mass of the target being measured.

As described above, the mass of the target to be measured can be detected by detecting the resonance frequency more than once as the liquid containing the target to be measured is flowed and by then computing the difference in resonance frequency.

Thus, even in the case where only one liquid is flowed, the mass of the target to be measured can be detected from the difference in resonance frequency obtained by more than one resonance frequency detection. It should be noted here that in the case of detecting the mass of the target to be measured from the difference in resonance frequency obtained by more than one resonance frequency detection, it is preferred to use a liquid with a small content of the target to be measured. Specifically, the preferred liquid is such that two different states will occur in the channel inside the cantilever, one where the target to be measured is flowing and the other where it is not, namely, such a liquid that the number of targets to be measured is less than unity per capacity of the channel inside the cantilever.

In an alternative case, the resonance frequency may be detected more than once irrespective of whether or not the target to be measured is flowing through the channel in the cantilever and the results are divided into three cases, the first case is where one target to be measured is flowing through the cantilever, the second case where two targets to be measured are flowing, and the third case where three targets are flowing; then, the differences between the respective cases are relied upon to detect the mass of the target being measured.

In the specific embodiment described above, the cantilever is vibrated once for detecting the resonance frequency once; however, this is not the sole case of the present invention and the timings at which the cantilever is vibrated and the resonance frequency is detected may be set in any desired way.

In the specific embodiment described above, the resonance frequency is repeatedly detected until a specified time is reached; however, the number of times the resonance frequency is detected and the criterion for determining the end of detection are not limited to the manner described above and one of the following alternative modes may be adopted: the resonance frequency is detected a predetermined number of times; the resonance frequency is detected repeatedly until after the liquid has finished flowing; or the resonance frequency is detected repeatedly until an operator's command is issued.

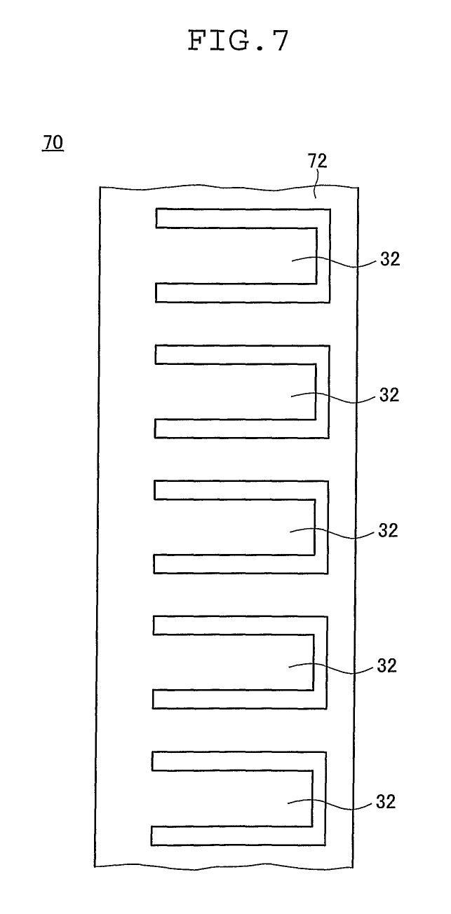

The specific embodiment described above contemplates the use of only one cantilever but if desired, more than one cantilever may be provided as shown in FIG. 7, where the main body 70 is adapted such that a plurality of cantilevers 32 are positioned in the support section 72.

Using a plurality of cantilevers enables more accurate sensing of the target to be measured. In addition, the experimental conditions may be gradually varied in the sequence of cantilevers to thereby enable the sensing of changes in the substance as the target to be measured.

Even in the case of providing a plurality of cantilevers, their vibration and detection of the resulting vibration can be performed by means of a single piezoelectric device that is provided for each cantilever and, hence, a compact apparatus can be realized. This enables the cantilevers to be arranged in high density and, what is more, they can be easily arranged to form an array configuration.

If a plurality of cantilevers are to be provided, the channels in adjacent cantilevers are preferably connected together. In other words, the outflux channel of one cantilever is preferably connected to the influx channel of the adjacent cantilever.

By connecting the channels in adjacent cantilevers, the same target to be measured can be measured a plurality of times. This allows for even more accurate sensing.

If desired, the same target to be measured may be sensed under different conditions (such as where the liquid varies in properties or under different temperature conditions).

In the foregoing embodiment, the mass of the target to be measured is sensed but this is not the sole case of the present invention and instead of the mass of the target to be measured, its presence or absence may be sensed. In this alternative case, the mass computing (or sensing) section is not operated to compute (or sense) the mass of the target to be measured but resonance frequency comparison may be performed to sense whether the target to be measured is within the channel in the cantilever.

In this case, a liquid for which it is not known whether it contains the target to be measured is flowed through the channel in the cantilever and the resonance frequency of the cantilever through which the liquid has been flowed is compared with the resonance frequency of the cantilever through which a liquid not containing the target to be measured has been flowed; if there is a change in resonance frequency, it follows that something other than the liquid has entered the channel.

As just described above, the substance sensing method of the present invention can also be utilized to detect the presence or absence of the target to be measured and because of the particularly high precision in measurement, it can even sense the presence or absence of a tinier substance.

In the foregoing embodiment, the cantilever is displaced and the frequency of the damped vibration that continues until it returns to the initial position is sensed to thereby sense the resonance frequency of the cantilever; however, this is not the sole case of the present invention and the frequency of vibration applied to the cantilever by the piezoelectric device may be gradually changed and the vibration of the cantilever at each of the frequencies applied is detected by the piezoelectric device so as to detect the resonance frequency of the cantilever. In this case, the frequency of vibration to be applied can be varied by changing the pulse width of the voltage being applied from the signal source to the upper electrode in the piezoelectric device.

In a preferred embodiment, the cantilever-type sensor is provided with a vessel that tightly seals the cantilever and which is evacuated to ensure that the cantilever is placed at a subatmospheric pressure; in a more preferred embodiment, a vacuum is created within the vessel.

By vibrating the cantilever at a subatmospheric pressure, namely, in thin air, the mechanical quality factor Q and, hence, the precision in measurement can be made higher; vibrating the cantilever in vacuo also contributes to increasing the precision in measurement to an even higher level.

The shape of the channel to be formed inside the cantilever is not limited in any particular way, either, and it may form a serpentine path that runs through the cantilever. If desired, the two segments of the channel that run in opposite directions may be superposed across the thickness of the cantilever.

The position in which the piezoelectric device is to be placed is by no means limited to the topside of the cantilever and it may be placed on the bottom side of the cantilever. Since the cantilever can be vibrated through a greater amplitude and the resonance frequency can be sensed from vibrations of the primary mode, the piezoelectric device is preferably positioned on the side of the cantilever that has the largest surface area, which is the topside or bottom side in the embodiment under consideration; if necessary, the piezoelectric device may be positioned on a lateral side of the cantilever.

In addition, the timing at which the resonance frequency of the cantilever is to be detected in the case where the liquid not containing the target to be measured is flowing through the channel is not limited in any particular way and it may be detected every time before the target to be measured is sensed or it may be detected after the target to be measured is sensed a specified number of times. If the same liquid is to be used in all measurements, the resonance frequency that is sensed during the first use may be adopted.

We next describe the process for producing the cantilever-type sensor of the present invention.

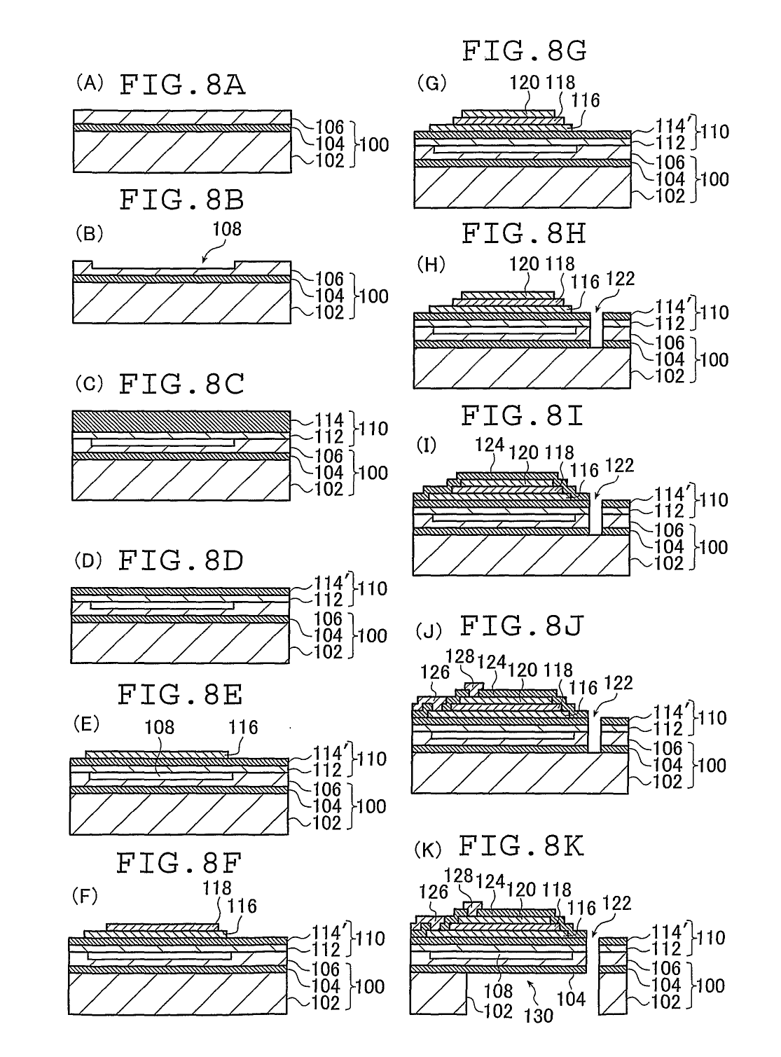

FIGS. 8A to 8K show the sequence of steps in an exemplary process for fabricating the main body of the cantilever-type sensor of the present invention.

The substrate with which the process starts is a SOI substrate 100 on which a Si layer 102, a SiO₂ layer 104 and a Si layer 106 are superposed (see FIG. 8R).

The Si layer 106 in the SOI substrate 100 is dry etched to form a channel 108 in it (see FIG. 8B).

Subsequently, a SOI substrate 110 in which a Si layer 112 and a SiO₂ layer 114 are superposed is attached to a surface of the Si layer 106 in the SOI substrate 100 (see FIG. 8C). Here the SOI substrate 100 and the SOI substrate 110 are assembled in such a way that the Si layer 106 and the Si layer 112 are bonded together. The method of attachment is not limited in any particular way and various techniques may be adopted, such as bonding with an adhesive.

Then, the SiO₂ layer 114 in the SOI substrate 110 is etched and polished to form a SiO₂ layer 114′ (see FIG. 8D).

Subsequently, a lower electrode 116 is formed on top of the SiO₂ layer 114′ in the SOI substrate 110 (see FIG. 8E). Specifically, a film of a metal such as Pt or Ti is provided on top of the SiO₂ layer 114′ by sputtering, attachment or some other suitable method, so as to form the lower electrode 116.

Then, a piezoelectric element 118 is formed on top of the lower electrode 116 (see FIG. 8F).

In a specific example, a PZT sinter is used as the target which is sputtered to form a PZT piezoelectric element 118 on top of the lower electrode 116. The method of forming the piezoelectric element 118 is not limited to sputtering and it may be attached to the lower electrode 116.

Subsequently, an upper electrode 120 is formed on top of the piezoelectric element 118 (see FIG. 8G). Specifically, a film of a metal such as Pt is provided on top of the piezoelectric element 118 by sputtering, attachment or some other suitable method, so as to form the upper electrode 120.

Then, the SiO₂ layer 114′, Si layer 112, Si layer 106 and the SiO₂ layer are successively etched to form a groove 122 (see FIG. 8H). Here, the groove 122 is formed along three sides (i.e., the two longer parallel sides and one shorter side) of the lower electrode 116 so as to separate two areas, one that is to form the cantilever and the other to form the support section. The one side that does not serve to form the groove 122 provides a joint between the cantilever and the support section.

Subsequently, a protective layer 124 is formed in the region where the lower electrode 116, piezoelectric element 118 and the upper electrode 120 are formed and in the surrounding area, namely, in the area that provides the cantilever and in the support section on the side that provides the joint to the cantilever (see FIG. 8I). Specifically, a SiO₂ film is formed by sputtering, plasma-enhanced CVD or other means on the upper surfaces of the region where the lower electrode 116, piezoelectric element 118 and the upper electrode 120 are formed and of the surrounding area, whereby the protective layer 124 is formed. By means of this protective layer 124, the exposed areas of the lower electrode 116, piezoelectric element 118 and the upper electrode 120 are covered to become electrically insulated.

Then, two openings are formed through the protective layer 124 such that one of them reaches a selected area of the upper surface of the lower electrode 116 while the other opening reaches a selected area of the upper surface of the upper electrode 120. Thereafter, a pickup electrode 126 is formed in the opening formed in the upper surface of the lower electrode 116 and a pickup electrode 128 is formed in the upper surface of the upper electrode 120 (see FIG. 8J).

Here, the method of forming two openings through the protective layer 124 may be exemplified by etching, and the method of forming the pickup electrodes 126 and 128 may be exemplified by sputtering. The metal which is to be used to form the pickup electrodes may be exemplified by Au.

In this way, a piezoelectric device is formed that is composed of the lower electrode 116, piezoelectric element 118, upper electrode 120, protective layer 124, as well as the pickup electrodes 126 and 128.

Thereafter, the Si layer 102 in the SOI substrate 100 is dry etched from the bottom side (the side of the SiO₂ layer 104 opposite from the Si Layer 106) to form an opening 130 (see FIG. 8K).

By forming the opening 130 in the Si layer 102, the support section comprising the SiO₂ layer and the overlying layers is separated, except in the joint, from the cantilever that is composed of the Si layers 106, 112 and the SiO₂ layers 104, 114′ in the other areas and which has a channel 108 formed therein.

Described above is the way one can fabricate the main body comprising the cantilever, the support section, and the piezoelectric element.

Thereafter, the liquid supply/recovery section, the mixer and any other necessary components are connected to the main body to thereby produce the cantilever-type sensor of the present invention.

Here, the cantilever-type sensor according to the first aspect of the present invention, the substance sensing system that uses it according to the second aspect of the invention, and the substance sensing method that uses it according to the third aspect of the invention can be utilized to analyze and sense tiny substances, for use in such applications as flow cytometry and screening in the development of new drugs.

While the cantilever-type sensor according to the first aspect of the present invention, the substance sensing system that uses it according to the second aspect of the invention, and the substance sensing method that uses it according to the third aspect of the invention have been described above in detail, it should be noted that the present invention is by no means limited to the foregoing embodiments and various improvements and modifications can be made without departing from the spirit and scope of the present invention.

For example, in the foregoing embodiments, only one end of the cantilever is fixed to the support section but it may be fixed at both ends. In other words, a member in plate form may be so adapted that both ends of it are fixed to the support section. If both ends of the cantilever in the cantilever-type sensor or beam-type sensor are fixed, it is no longer a “cantilever” and the amplitude of its vibration will become smaller but, on the other hand, it can be rendered more durable. In another modification, the channel may be a straight line that bends nowhere in opposite direction, in other words, it may simply extend from one joint between the member in plate form and the support section to the other joint. Adapting the channel inside the cantilever to assume such a straight path contributes to preventing it from becoming blocked by the substance of interest and, consequently, the precision in measurement can be enhanced in the case where the sensor is utilized more than once.

1. A cantilever-type sensor for detecting a substance to be measured as it is contained in a liquid, comprising:
a cantilever that is fixed at least at an end to a support section and which has a channel formed inside;
a piezoelectric device that is composed of a piezoelectric element and electrode sections formed on opposite sides of said piezoelectric element and which is positioned on at least one side of said cantilever;
a drive section that applies a voltage to said electrode sections of said piezoelectric device so as to vibrate said cantilever;
a detecting section that detects vibration of said cantilever from expansion or contraction of said piezoelectric device; and
liquid supply means for flowing the liquid through said channel in said cantilever.

2. The cantilever-type sensor according to claim 1, wherein said piezoelectric element is made of a composition of a Pb-containing perovskite crystal.

3. The cantilever-type sensor according to claim 1, wherein said piezoelectric element is made of a composition of a Pb-free perovskite crystal.

4. The cantilever-type sensor according to claim 1, wherein only one end of said cantilever is fixed to said support section.

5. The cantilever-type sensor according to claim 1, wherein both ends of said cantilever are fixed to said support section.

6. A substance sensing system comprising:
the cantilever-type sensor according to claim 1;
a frequency computing section which computes a first resonance frequency of said cantilever from a value detected by said detecting section; and
a sensing section which compares the first resonance frequency computed by said frequency computing section with a second resonance frequency of said cantilever for a case where a liquid not containing the substance to be measured is flowed through said channel and which relies on a result of comparison to sense the substance to be measured as it is inside said channel.

7. The substance sensing system according to claim 6, wherein said sensing section relies on the result of comparison to sense a mass of the substance being measured.

8. The substance sensing system according to claim 6, wherein said sensing section relies on the result of comparison to sense presence or absence of the substance being measured.

9. A substance sensing method for sensing a substance to be measured within a liquid, comprising:
flowing the liquid through a channel formed inside a cantilever having a piezoelectric device positioned on at least one side thereof;
applying a voltage to said piezoelectric device so that said piezoelectric device is expanded or contracted to vibrate said cantilever as the liquid is flowing therethrough;
detecting vibration of said cantilever with said piezoelectric device;
detecting from the detected vibration a first resonance frequency of said cantilever as the liquid is flowing therethrough;
comparing the detected first resonance frequency with a second resonance frequency of said cantilever for a case where a liquid not containing the substance to be measured is flowed through said channel; and
sensing the substance to be measured from a result of comparison.

10. The substance sensing method according to claim 9, wherein the mass of the target being measured is sensed from the result of comparison.
